(19) United States
(12) Patent Application Publication
(10) Pub. No.: US 2016/0217192 A1
(43) Pub. Date: Jul. 28, 2016

(54) SEARCH SYSTEM AND SEARCH METHOD

(71) Applicant: HITACHI, LTD., Tokyo (JP)

(72) Inventors: Hiromu HOTA, Tokyo (JP); Shoji KODAMA, Tokyo (JP); Hiroyasu NISHIYAMA, Tokyo (JP)

(73) Assignee: HITACHI, LTD., Tokyo (JP)

(21) Appl. No.: 15/023,490

(22) PCT Filed: Oct. 2, 2013
(86) PCT No.: PCT/JP2013/076763

§ 371 Date: Mar. 21, 2016

(51) Int. Cl. G06F 17/30

(52) U.S. Cl. CPC G06F 17/30569; G06F 17/30445; G06F 17/30545; G06F 17/30218

(57) ABSTRACT

A search system using a table search server and a file search server as transmission destination candidates for search queries, wherein search speed is assumed to be higher for a search in the form of file data than for table data, the table data is converted to file data and stored in the file search server. Created are a search query history management table for accumulating and depositing search query history, and a characteristic determination rule management table for managing the rules of determining that the search speed is higher for a search made in the form of file data than for table data. The search system applies the characteristic determination rules to the search query history and specifies the table data. The search system acquires the specified table data from the table search server, converts the data to file data, and stores the data in the file search server.

### TECHNICAL FIELD

The present invention relates to a search system and a search method.

### BACKGROUND ART

With the growth of the Internet, there is an enormous number of file data, such as text, image, and voice. To completely process the enormous number of file data in real time, distributed processing may be performed using a plurality of computers. For example, Hadoop as a distributed processing framework distributes and stores the file data into the plurality of computers, and sends a processing instruction to each of the computers. Then, each of the computers executes processing for the file data respectively stored therein. Patent Literature 1 discloses creation of one table data by integrating table data stored in RDB (Relational Database) and an XML file stored in an XML DB (eXtensible Markup Language Database).

Patent Literature 2 discloses creation of one table data, by creating an adopting result of a natural language analysis method to text file data as table data and integrating the table data and another table data.

### CITATION LIST

### Patent Literature

PTL 1: U.S. Pat. No. 8,195,647

PTL 2: Japanese Patent Application Publication No. 2010-205077

### SUMMARY OF INVENTION

### Technical Problem

Conventionally, data types and data processing programs are fixed on one-to-one basis, and each of the processing programs is stored in a storage managed thereby. For example, in case of structure data, such as table data, it is processed in RDB, and stored as database. In case of non-structure data, such as text data or time-series data, it is processed with Hadoop, and stored in a file managed thereby. Then, the data processing has been performed in the storage destinations. However, the data storage destinations may not be appropriate in terms of cost and performance. For example, it may be appropriate to store the table data contents in the file managed by Hadoop and to process it with Hadoop, and it may be appropriate to store the time-series data in the database managed by the RDB and to process it with the RDB. Specifically, in a process for aggregating very large data, the table data is divided and stored in the file of Hadoop. If the data is processed with Hadoop, the process time may be short. Accordingly, it is necessary to determine the data storage destination, in consideration of the processing characteristics (aggregation or search) for the data, instead of the data type, such as the table data or file data.

The data processing characteristics can be determined based on the processing history.

There is no need for the manager of the information system to determine the processing characteristic of each data, by determining the data processing characteristic from the history.

The processing characteristic for the data may possibly be changed with time. Thus, it is desired to determine the appropriate data processing characteristic in accordance with the change of the processing characteristic.

### Solution to Problem

To solve the above problem, in a search system having a table search server and a file search server as transmission destination candidates for a search query, table data is specified. It is recognized that this table data is searched at a higher speed when it is searched as file data than for a search in the form of table data. In addition, the specified table data is converted into file data, and stored in the file search server. For this storage, what are required are a search query history management table accumulating and keeping search query histories, a characteristic determination rule management table managing a rule for determining that it is faster to search data as file data than to search the data as table data, and a data movement technique for converting table data into file data based on a determination result and storing it into the file search server.

According to the present application, there is provided a search system including a table search unit for searching for data in a table format and a file search unit for searching parallelly for data in a plurality of file formats, including: a table data memory area which stores target table format data to be searched by the table search unit; a file data memory area which stores target file format data to be searched by the file search unit; and a performance determination unit which specifies a part of the table format data, in unit of rows, which is recognized to be searched at a high speed when it is searched as file format data, when the table search unit searches for the table format data; and wherein the specified part of table format data is stored in the unit of rows, and stored in the file data memory area.

### Advantageous Effects of Invention

Reduction in search time and reduction in data management cost, due to automation of data movement.

### BRIEF DESCRIPTION OF DRAWINGS

FIG. 1 is an example of a system configuration diagram.

FIG. 2 is an example of a search system configuration diagram.

FIG. 3 is an example of a file search server configuration diagram.

FIG. 4 is a diagram illustrating an example of a search server characteristic management table.

FIG. 5 is a diagram illustrating an example of a data storage destination management table.

FIG. 6 is a diagram illustrating an example of a search query history management table.

FIG. 7 is a diagram illustrating an example of a movement data candidate characteristic management table.

FIG. 8 is a diagram illustrating an example of a characteristic determination rule management table.

FIG. 9 is a diagram illustrating an example of an aggregate function management table.

FIG. 10 is a diagram illustrating an example of a data movement management table.

FIG. 11 is a diagram illustrating an example of a data storage destination management table, after data movement.

FIG. 12 is an example of a process for a search query by a search system.

FIG. 13 is an example of a process for a search query by a table search server.

FIG. 14 is an example of a process for a search query by a file search server.

FIG. 15 is an example of a process of a performance determination unit.

FIG. 16 is an example of a process of a data movement unit.

FIG. 17 is an example of a management image.

FIG. 18 is an example of an SQL query which has been converted into a format processable by the file search server.

FIG. 19 is an example in which table data is divided and converted into a file.

FIG. 20 is a conversion example of an XML file.

FIG. 21 is a conversion example of a text file.

### DESCRIPTION OF EMBODIMENT

### Example 1

In this example, descriptions will now be made to a history calculating method for a search query, a determination method for movement data, and a data movement method. In this example, descriptions will be made to a case in which table data stored in a table search server is divided, the divided table data is converted into files, the converted files are stored in a file search server, and the table data is deleted from the table search server.

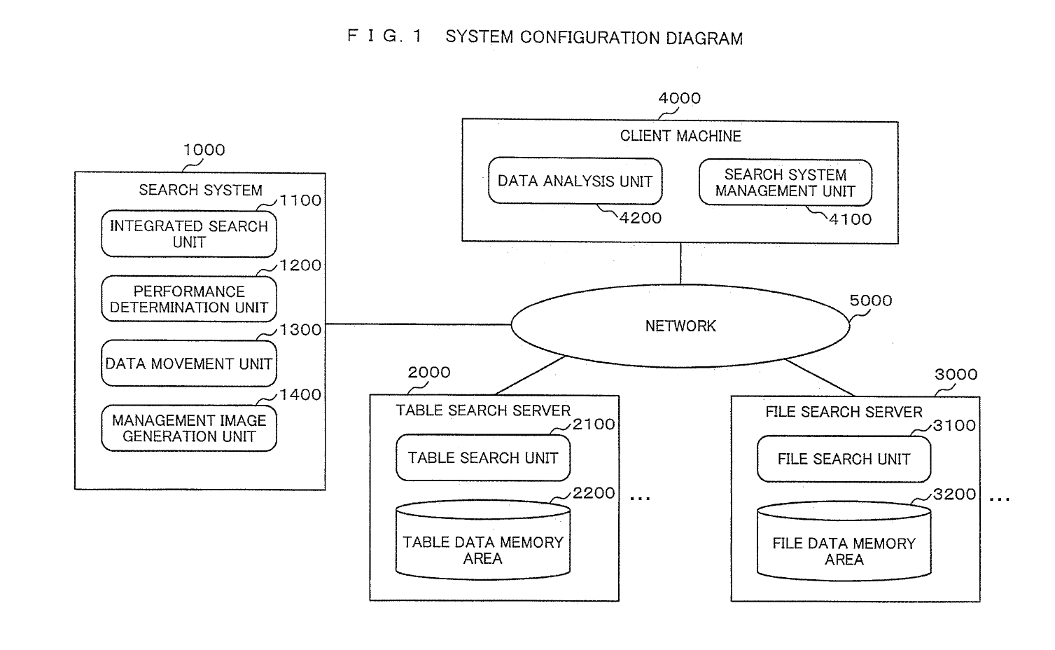

FIG. 1 is a diagram illustrating an example of a system configuration in the example of the present invention. Connected through a network 5000 are a search system 1000, a table search server 2000, a file search server 3000, and a client machine 4000. Pluralities of the table search server 2000, the file search server 3000, and the client machine 4000 may possibly be provided. The table search server 2000 is formed of a table search unit 2100 and a table data memory area 2200. The file search server 3000 is formed of a file search unit 3100 and a file data memory unit 3200. As will be described later, the file search server is formed of a representative node 3010 and a plurality of member nodes 3020. The client machine 4000 is formed of a search system management unit 4100 and/or a data analysis unit 4200.

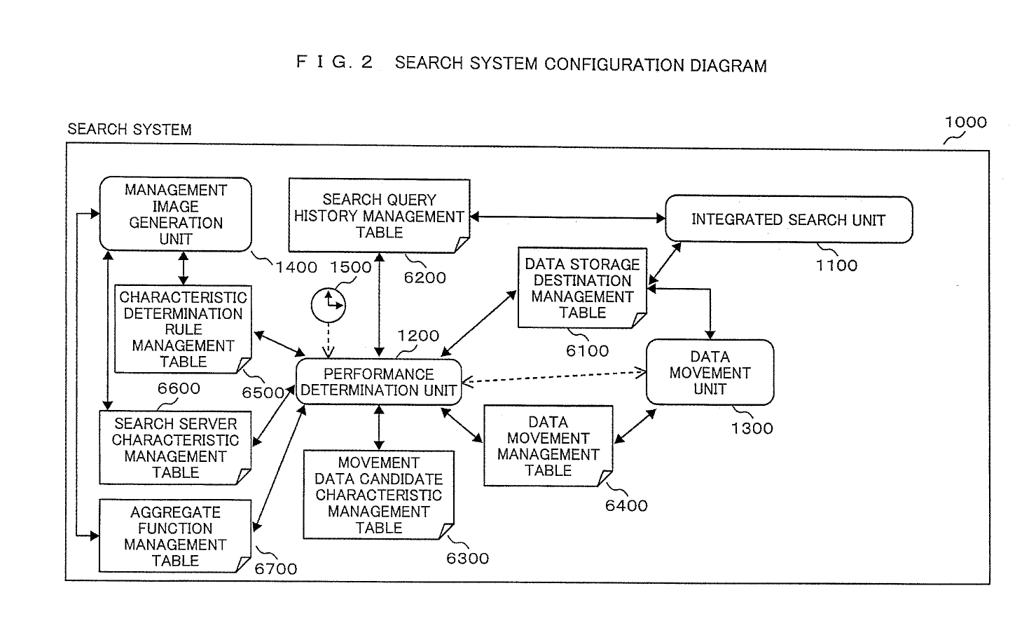

FIG. 2 is an explanatory diagram illustrating an example of a configuration of the search system 1000. The search system 1000 is formed of an integrated search unit 1100, a performance determination unit 1200, a data movement unit 1300, a management image generation unit 1400, and a timer 1500. The search system 1000 has a data storage destination management table 6100, a search query history management table 6200, a movement data candidate characteristic management table 6300, a data movement management table 6400, a characteristic determination rule management table 6500, a search server characteristic management table 6600, an aggregate function management table 6700.

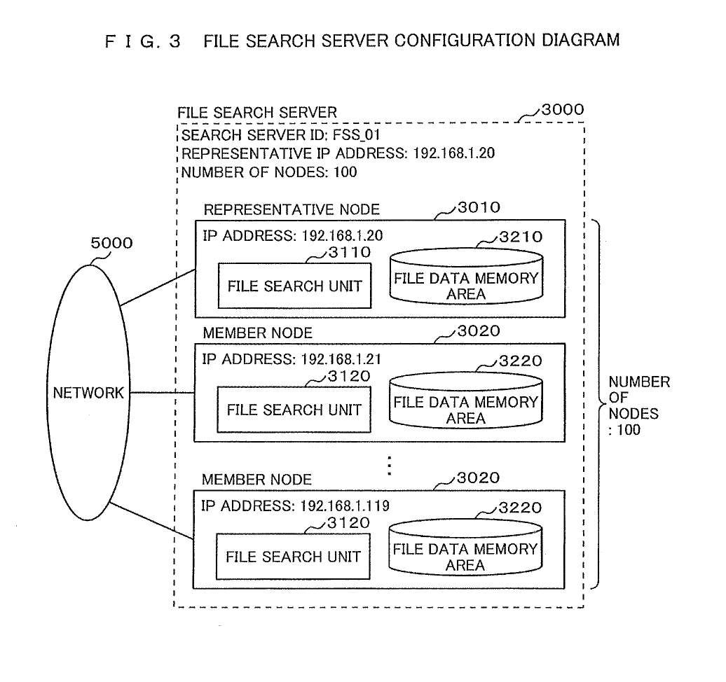

FIG. 3 is an explanatory diagram illustrating an example of a configuration of the file search server 3000. The file search server 3000 is identified by a search server ID, a representative IP address, and the number of nodes. The file search server 3000 is formed of the representative node 3010 and the member nodes 3020. The representative node 3010 and the member nodes 3020 are connected with each other through the network 5000, and are specified by the IP address. The representative node 3010 is formed of a file search unit 3110 and a file data memory area 3210. Each of the member nodes 3020 is formed of a file search unit 3120 and a file data memory area 3220.

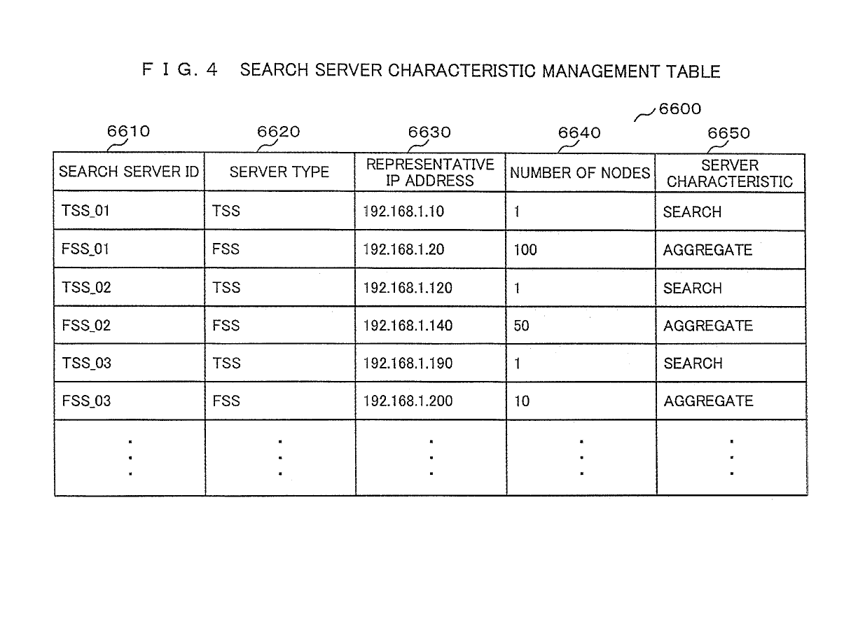

FIG. 4 is a diagram illustrating an example of a configuration of the search server characteristic management table 6600. The search server characteristic management table 6600 stores information of each search server. Specifically, it includes a search server ID 6610, a server type 6620, a representative IP address 6630, the number of nodes 6640, and a server characteristic 6650. The server type 6620 takes a value of “TSS” or “FSS”, and represents that the server type is either the table search server 2000 (TSS) or the file search server 3000 (FSS). The server characteristic 6650 takes a value representing “search” or “aggregate”, and represents that the corresponding search server is suitable for a search process or an aggregation process. A judgment of whether it is suitable therefor may be made in accordance with the high processing speed or the little remaining amount of consumption memory area.

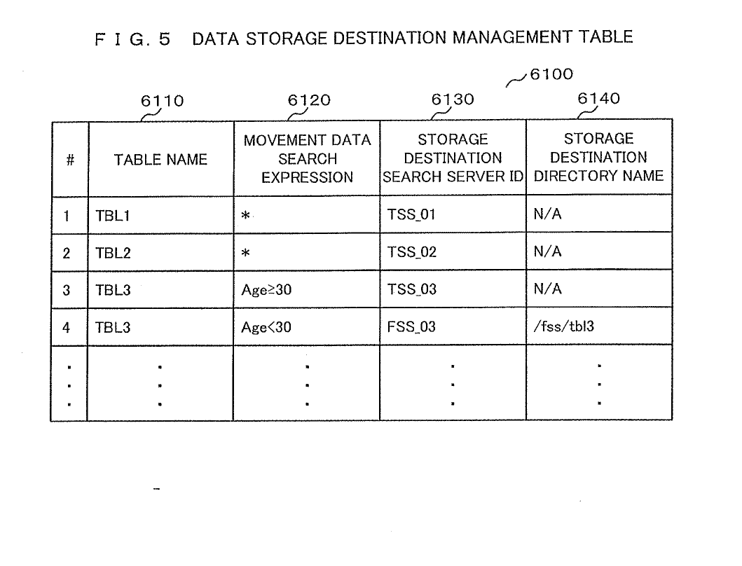

FIG. 5 is a diagram illustrating an example of a configuration of a data storage destination management table 6100. The data storage destination management table 6100 stores information regarding a search server storing data groups that are specified using table names and movement data search expressions. Specifically, it is formed of a table name 6110, a movement data search expression 6120, a storage destination search server ID 6130, and a storage destination directory name 6140.

The movement data search expression 6120 represents a conditional expression described in a “where” statement of SQL queries. Data can uniquely be designated, by combining the table name 6110 and the movement data search expression 6120. In this example, the table name 6110=“TBL3” and the movement data search expression 6120=“Age<30” designate a data group whose Age in TBL3 is lower than 30. The movement data search expression 6120=“*” represents that the entire data groups in the corresponding table are designated.

The storage destination directory name 6140=“N/A” represents that the server type 6620 of the search server corresponding to the storage destination search server ID 6130 is “TSS” (the table search server 2000). In the table search server 2000, data is managed using the table name 6110, instead of the directory name.

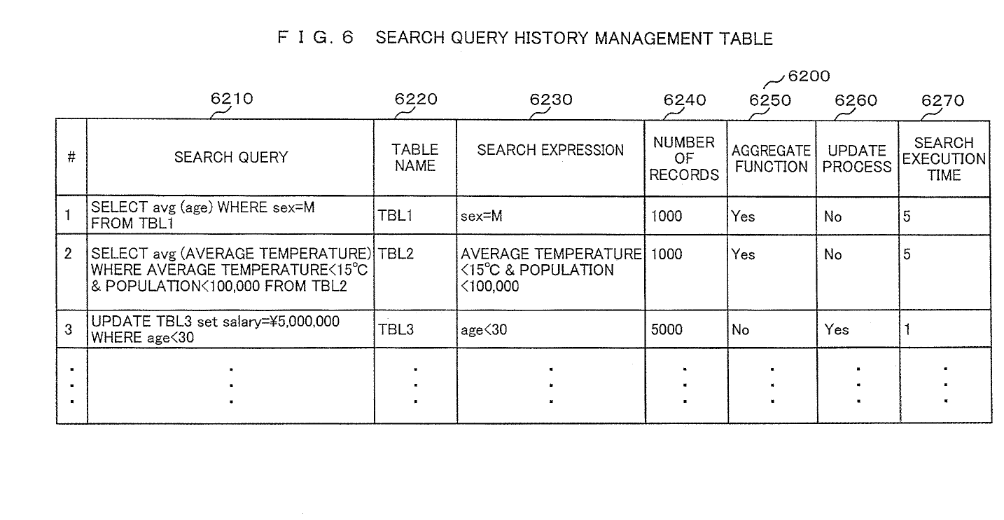

FIG. 6 is a diagram illustrating an example of a configuration of the search query history management table 6200. The search query history management table 6200 stores histories of search queries. Specifically, it is formed of a search query 6210, a table name 6220, a search expression 6230, number of records 6240, an aggregate function 6250, an UPDATE process 6260, and a search execution time 6270.

The search query 6210 stores a search query which has been received by the integrated search unit 1100 from the data analysis unit 4200. The table name 6220 and the search expression 6230 register the table name and the search expression that are extracted from the corresponding search query. The number of records 6240 registers the number of data items of the data group specified by the table name 6220 and the search expression 6230. The aggregate function 6250 stores “Yes” if the search query 6210 includes any function 6710 registered in the aggregate function management table 6700 as will be described later, and stores “No” if not. The UPDATE process 6260 stores “Yes” if the search query 6210 has an UPDATE process, and stores “No” if not. The search execution time 6270 stores the required time, since the integrated search unit 1100 receives a search query from the data analysis unit 4200 until the integrated search unit 1100 returns a search result to the data analysis unit 4200.

For example, a Process time or an Elapsed time may be used as the search execution time 6270. The process time represents a period of time the Central Processing Unit of the search system 1000 has operated for the search query process. Thus, even if the Central Processing Unit is performing any process at the same time as the search query process, the Process time represents an accurate process time for the search query. However, the Process time does not include a period of time required for transmitting the search query from the search system 1000 to the table search server 2000 or the file search server 3000. This may make divergence from the search execution time that the user feels. To express the search execution time that the user can feel, the above-described Elapsed time may be adopted.

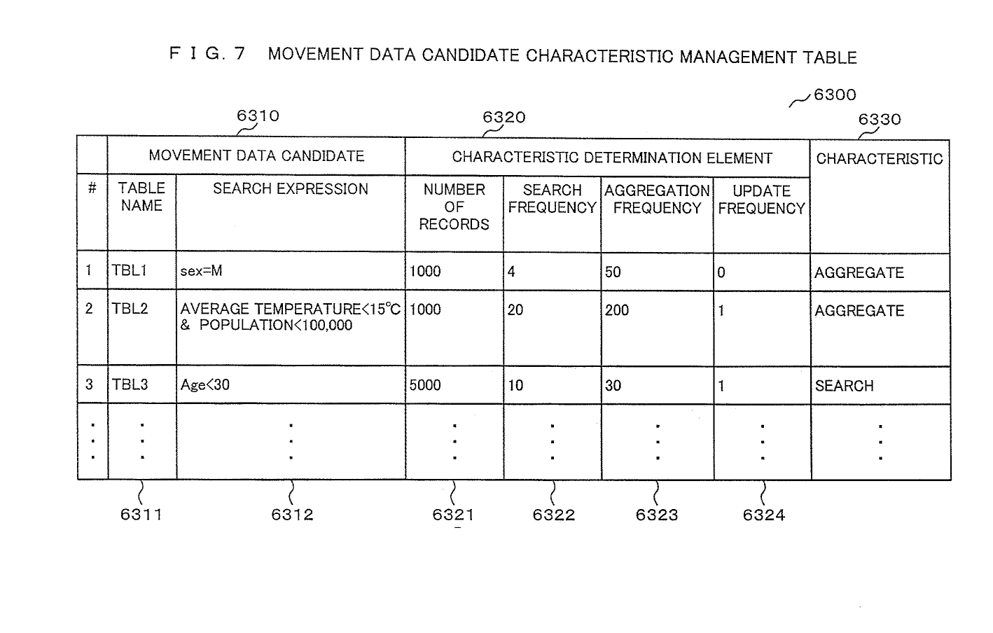

The search execution time 6270 is an index based on an execution result of actual search. Thus, if it is used with priority other than indexes of the number of records, the search frequency, and the Update frequency that are used for data movement and explained in FIG. 7, the search time can further be reduced.

FIG. 7 is a diagram illustrating an example of the movement data candidate characteristic management table 6300. The movement data candidate characteristic management table 6300 stores a movement data candidate 6310, a characteristic determination element 6320 of the movement data candidate, and a characteristic 6330 of the movement data candidate. Specifically, it is formed of a table name 6311, a search expression 6312, number of records 6321, a search frequency 6322, an aggregation frequency 6323, an UPDATE frequency 6324, and the characteristic 6330. A general term for the table name 6311 and the search expression 6312 is the movement data candidate 6310, while a general term for the number of records 6321, the search frequency 6322, the aggregation frequency 6323, and the UPDATE frequency 6324 is the characteristic determination element 6320.

The movement data candidate 6310 and the characteristic determination element 6320 of the movement data candidate characteristic management table 6300 are obtained by calculating the search query history management table 6200. The calculation method will specifically be described later.

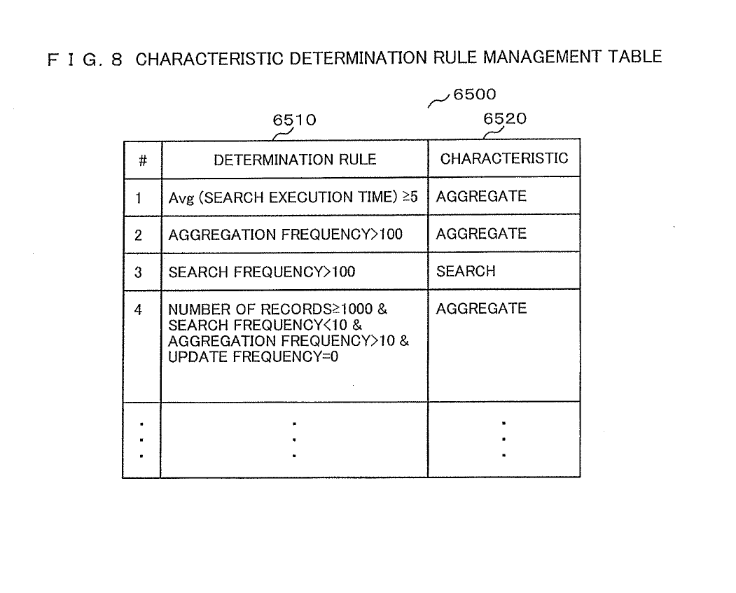

FIG. 8 is a diagram illustrating an example of a configuration of the characteristic determination rule management table 6500. The characteristic determination rule management table 6500 stores a rule for determining the characteristic of a search query. Specifically, it is formed of a determination rule 6510 and a characteristic 6520. The determination rule 6510 is a logical expression including the characteristic determination element 6320. For example, in the characteristic determination rule management table 6500 illustrated in FIG. 8, the determination rule 6510 of the first row is “the average value of the search execution time is 5 (seconds) or greater”. Needless to say, it may be “the maximum value of the search execution time is 5 (seconds) or greater”. When the determination rule 6510 is true, the characteristic 6520 corresponding to the corresponding determination rule 6510 is assumed as a characteristic of the search query.

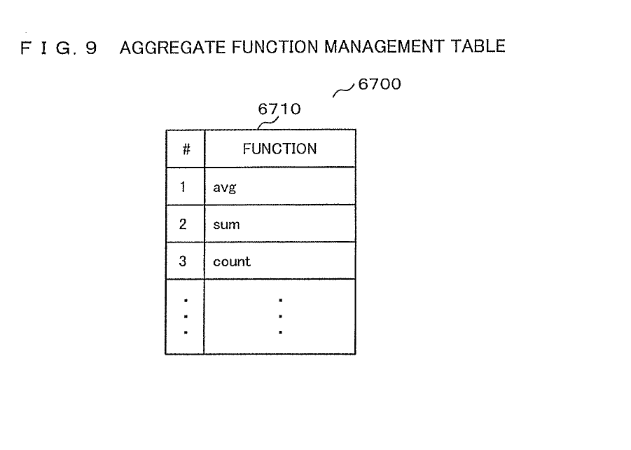

FIG. 9 is a diagram illustrating an example of a configuration of the aggregate function management table 6700. The aggregate function management table 6700 stores functions for aggregating a target data group to be processed. Specifically, it is formed of a function 6710. An example of the aggregate functions is “avg” for calculating the average value of the target data group to be processed.

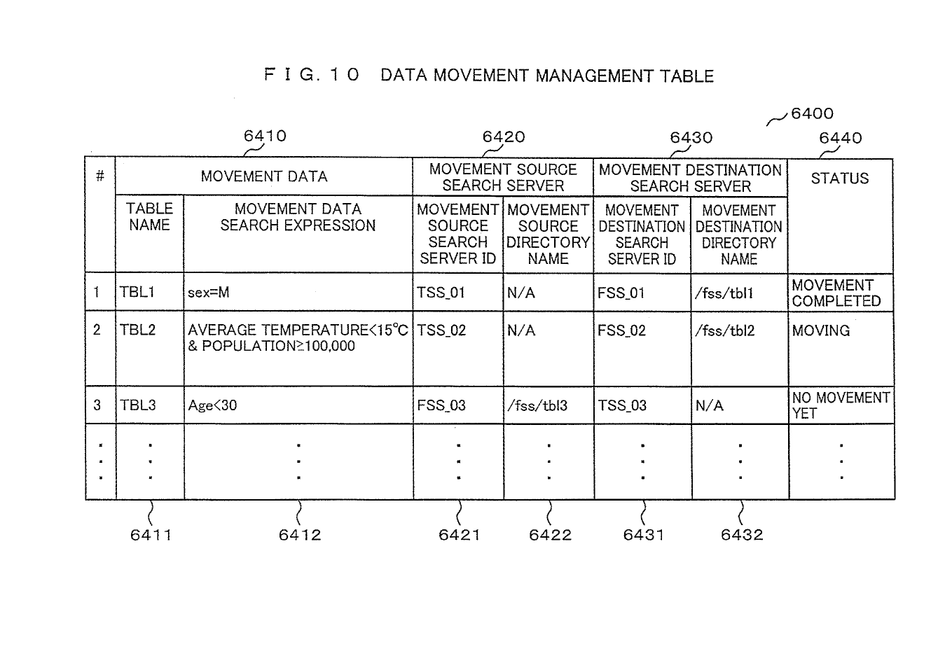

FIG. 10 is a diagram illustrating an example of a configuration of the data movement management table 6400. The data movement management table 6400 stores the movement data, the movement source, the movement destination, and the status. Specifically, it is formed of a table name 6411, a movement data search expression 6412, a movement source search server ID 6421, a movement source directory name 6422, a movement destination search server ID 6431, a movement destination directory name 6432, and a status. 6440. A general term for the table name 6411 and the movement data search expression 6412 is movement data 6410, a general terminal for the movement source search data ID 6421 and the movement source directory name 6422 is a movement source search server 6420, and a general term for the movement destination search server ID 6431 and the movement destination directory name 6432 is a movement destination search server 6430.

The performance determination unit 1200 compares the movement data candidate characteristic management table 6300 and the search server characteristic management table 6600. When the characteristic 6300 of the movement data candidate 6310 does not match with the server characteristic 6650 of the storage destination search server of the movement data candidate 6310, a search server with the characteristic 6330 of the movement data candidate 6310 is assumed as a movement destination, and in the data movement management table 6400, the movement candidate, the movement source, and the movement destination are registered in the data movement management table 6400. A method for forming the data movement management table 6400 will specifically be described later.

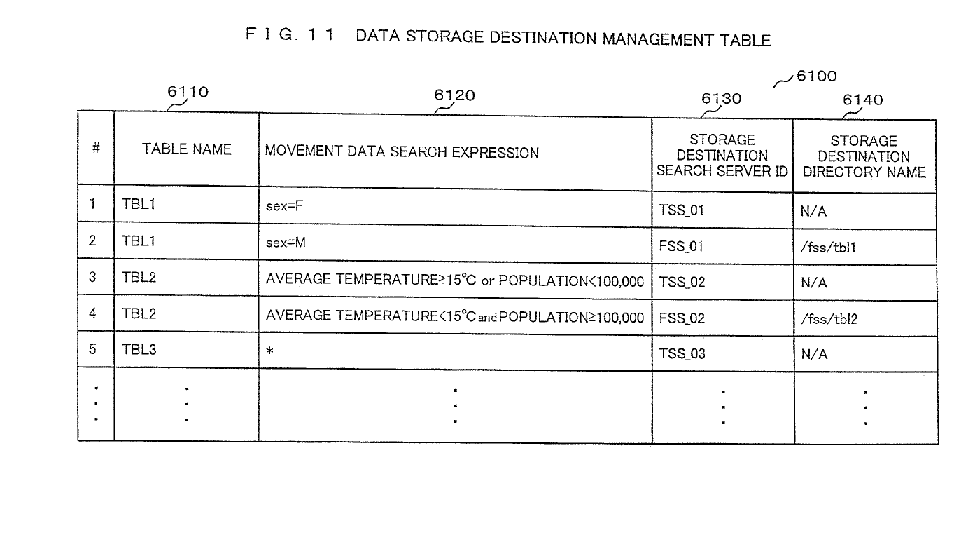

FIG. 11 is an example of the data storage destination management table 6100 after data movement in accordance with the data movement management table 6400. For example, by data movement in the first row of the data movement management table 6400, a partial data group of a table “TBL1” is moved from a search server “TSS_01” to a search server “FSS_01”. Thus, in the first row of FIG. 11, of the table “TBL1”, stored is information of a difference set (the table name 6110 “TBL1” and the movement data search expression 6120 “sex=F”) of the movement data (the table name 6110 “TBL1” and the movement data search expression 6120 “*”) in the first row of FIG. 5 and the movement data 6410 (the table name 6411 “TBL1” and the movement data search expression 6412 “sex=M”). In the second row of FIG. 11, stored is information (the table name 6411 “TBL1” and the movement data search expression 6412 “sex=M”) of the movement data 6410.

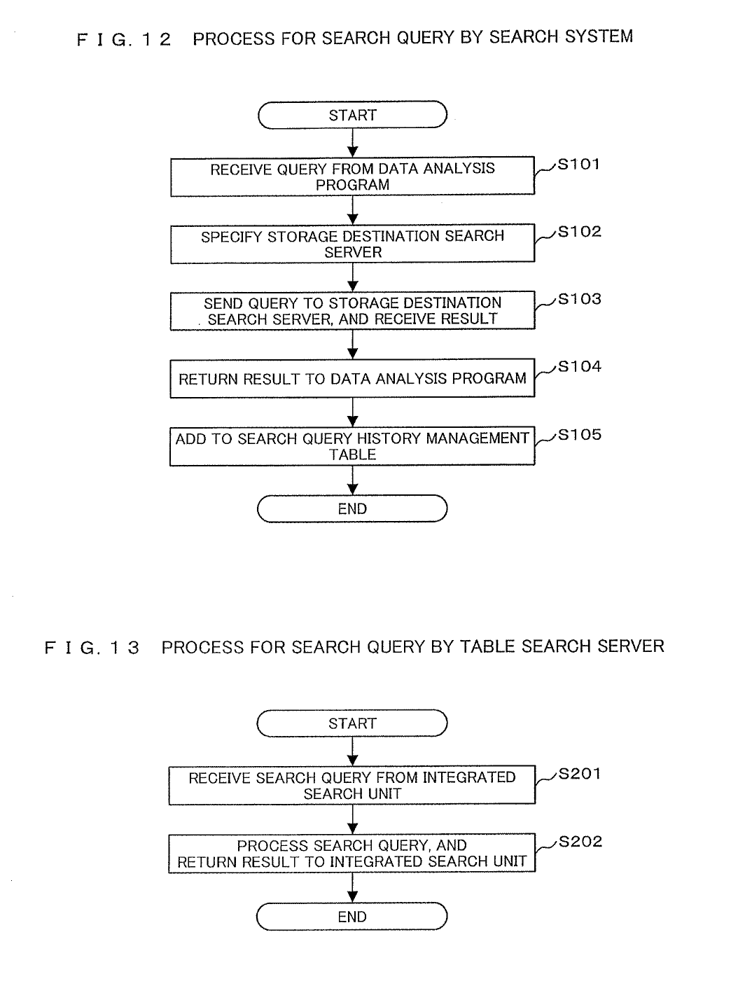

FIG. 12 illustrates the flow for processing a search query that the search system 1000 has received from the data analysis unit 4200. In this process, the integrated search unit 1100 sends a search query to the table search server 2000 and/or the file search server 3000, and a result is returned to the data analysis unit 4200.

First, Step S101 will be described. In Step S101, the integrated search unit 1100 receives a search query from the data analysis unit 4200. In this case, the table name included in the search query and the data group specified by the search expression are called “process data”.

Next, Step S102 will be described. In Step S102, the integrated search unit 1100 specifies a search server storing process data. Specifically, the integrated search unit 1100 refers to the data storage destination management table 6100, specifies a row in which the table name included in the search query is registered in the table name 6110 and in which the movement data search expression 6120 including the search expression included in the search query is registered, and specifies a storage destination search server corresponding to the specified row.

The integrated search unit 1100 refers to the data storage destination management table 6100, and specifies the entire rows in which the table name included in the search query is registered in the table name 6110.

Next, the integrated search unit 1100 determines the inclusion relation of the movement data search expression 6120 and the search expression included in the search query, in association with each of the specified entire rows.

When there exists the specified row having the movement data search expression 6120 including the search expression included in the search query, the integrated search unit 1100 acquires the storage destination search server ID 6130 and the storage destination directory name 6140, of the corresponding row. The integrated search unit 1100 refers to the search server characteristic management table 6600, to acquire the representative IP address 6630 corresponding to the acquired storage destination search server ID 6130.

When there does not exist the specified row having the movement data search expression 6120 including the search expression included in the search query, it acquires the storage destination search server ID 6130 and the storage destination directory name 6140, in association with each of the specified rows. The integrated search unit 1100 refers to the search server characteristic management table 6600, to acquire the representative IP address 6630 corresponding to each of the acquired storage destination search server IDs 6130.

When there does not exist the specified row having the movement data search expression 6120 including the search expression included in the search query, it represents that the storage destination of the process data is unknown or that the storage destination of the process data has been distributed to a plurality of search servers. For example, it is assumed to specify a search server storing the process data identified by the table name “TBL1” and the search expression “age<30” included in the search query “select*where age<30 from TBL1”. In the example of the data storage destination management table 6100 illustrated in FIG. 11, it is possible to specify that the first and second rows are registered as those whose table name “TBL1” is registered in the table name 6110. However, of the first and second rows in the data storage destination management table 6100 illustrated in FIG. 11, there is no row having the movement data search expression 6130 including the search expression “age<30”. These are the descriptions of Step S102.

In Step S103, the integrated search unit 1100 sends the search query and the acquired storage destination directory name 6140 to the storage destination search server corresponding to the acquired representative IP address 6630, that is, the storage destination search server ID 6610. The search query received by each storage destination search server is processed, and the result is returned to the integrated search unit 1100. At this time, after the search query has been converted into a format that is processable by the storage destination search server, the integrated search unit 1100 sends the search query after converted to each storage destination search server.

The integrated search unit 1100 refers to the data movement management table 6400, to acquire the movement source search server 6420, the movement destination search server 6430, and the status 6440, in the movement data 6410.

The search query is any of a SELECT request, an UPDATE request, an INSERT request, and a DELETE request. The three requests except the SELECT request are to change the contents of the process data. Thus, when the search query is any request other than the SELECT request, and when the acquired status 6440 is “moving”, the changed contents of the process data in response to the search query need to be reflected also in the movement destination search server 6430, at the same time as processing the search query from the data analysis unit 4200. This is because, when data was deleted by accident, in a state where the changed contents are reflected only onto the data stored in the movement source search server 6420, the changed contents will undesirably be lost without being reflected onto the data stored in the movement destination search server 6430.

Accordingly, a determination is made as to whether the search query is other than the SELECT request, and whether the acquired status 6440 is “moving”. When the request query is other than the SELECT request, and when the acquired status 6440 is “moving”, the integrated search unit 1100 sends a search query to the movement destination search server 6430, and the movement destination search server 6430 processes the search query and returns it to the integrated search unit 1100. At this time, after the search query into a format that is processable by the movement destination search server 6430, the integrated search unit 1100 sends the converted search query to the movement destination search server 6430.

When it is not possible or it is difficult to specify a search server storing the process data, the query may be sent to the entire possible search servers which may store the process data, and a search result may be received from the search servers with the sent query.

It is possible to reduce the load of specifying the search server storing the process data, by registering in advance the possible search server(s) which stores the process data.

These are the descriptions of Step S103.

Finally, the integrated search unit 1100 returns the result to the data analysis unit 4200 (Step S104), adds the search query to the search query history management table 6200 (Step S105), and ends the process.

FIG. 13 illustrates the flow in which the table search unit 2100 of the table search server 2000 receives a search query from the integrated search unit 1100 (Step S201), processes the received search query, and returns the result to the integrated search unit 1100 (Step S202).

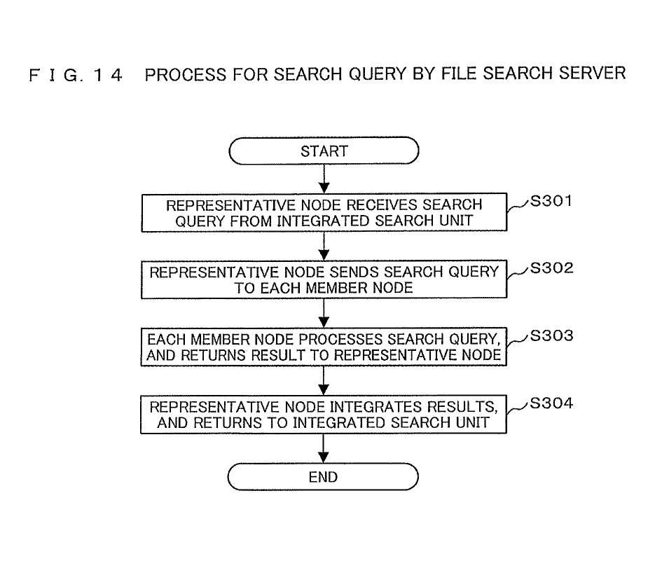

FIG. 14 illustrates the flow in which the file search server 3000 processes the search query received from the integrated search unit 1100, and returns the result to the integrated search unit 1100.

First, the file search unit 3110 of the representative node 3010 of the file search server 3000 receives a search query which has been converted into a format processable by the file search server 3000 from the integrated search unit 1100 (Step S301).

Next, the file search unit 3110 of the representative node 3010 sends the search query after converted to the file search unit 3120 of each member node 3020 (Step S302).

The file search unit 3120 of each member node 3020 which has received the search query after converted processes the search query, and returns the result to the file search unit 3110 of the representative node 3010 (Step S303).

Finally, the file search unit 3110 of the representative node 3010 integrates the results, and returns them to the integrated search unit 1100 (Step S304).

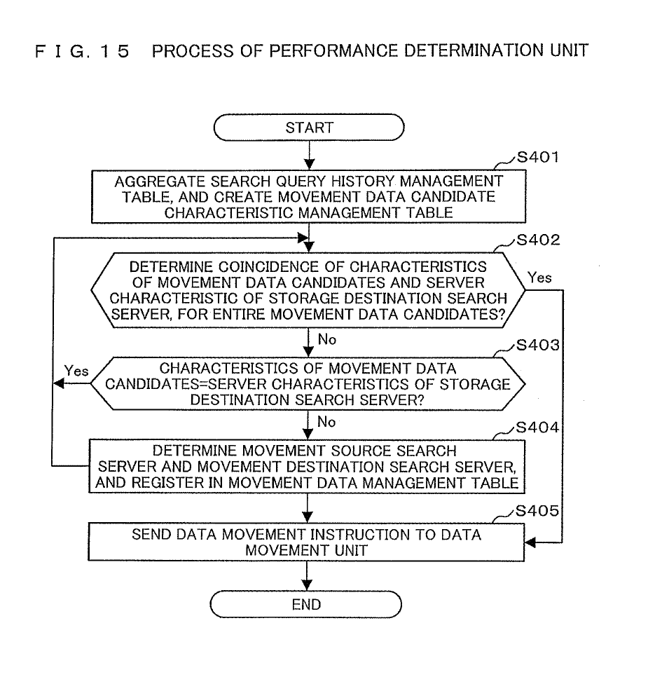

FIG. 15 illustrates a process in which the performance determination unit 1200 calculates the search queries at every constant time period in accordance with the timer 1500, determines a movement data candidate(s), and finally determines the data movement.

The unit calculates the search queries 6210 of the search query history management table 6200, to create the movement data candidate characteristic management table 6200 (Step S401).

For each row of the search query history management table 6200, a unique set of the table name 6220 and the search expression 6230 are stored in the movement data candidate characteristic management table 6300, as the movement data candidate 6310. At this time, the number of records 6321 is copied.

A row, having the same table name 6220 as that included in the target row to be processed in the movement data candidate characteristic management table 6300 and the search expression 6230, is extracted from the search query history management table 6200. Then, the search frequency 6322, the integration frequency 6323, and the UPDATE frequency 6324 are calculated, and stored in the movement data candidate characteristic management table 6300.

Note that the calculation frequency 6323 represents the number of times each function 6710 registered in the aggregate function management table 6700 is included in the search query 6210, the search frequency 6322 represents the number of times the aggregation frequency 6323 is subtracted from the number of the SELECT requests, and the UPDATE frequency 6324 represents the number of the UPDATE requests.

Finally, it is examined whether there is a determination rule that the characteristic determination element 6320 corresponding to the movement data candidate 6310 satisfies the determination rule 6510 of the characteristic determination rule management table 6500. When there is found the satisfying determination rule, the characteristic 6520 of the corresponding determination rule is stored in the characteristic 6330 of the movement data candidate characteristic management table 6300.

For the entire rows of the movement data candidate characteristic management table 6300, a determination is made as to whether a matching determination between the characteristic 6330 of the movement data candidate and the server characteristic 6650 of the storage destination search server of the movement data has been completed (Step S402).

For the entire of the movement data candidate characteristic management table 6300, if the matching determination has been completed, the flow proceeds to Step S405. If the matching determination has not been completed, the flow proceeds to Step S403.

For each row of the movement data candidate characteristic management table 6300, a determination is made as to whether the characteristic 6330 of the movement data candidate matches with the server characteristic 6650 of the storage destination search server of the movement data (Step S403).

With reference to the data storage destination management table 6100, the unit acquires the storage destination search server ID 6130 and the storage destination directory name 6140 corresponding to the table name 6311 and the search expression 6312 of the movement data candidate characteristic management table 6300.

Further, with reference to the search server characteristic management table 6600, the unit acquires the server characteristic 6650 of the search server corresponding to the acquired storage destination search server ID 6610. A determination is made as to whether the characteristic 6330 of the movement data candidate characteristic management table 6300 is the same as the server characteristic 6650 of the acquired storage destination search server.

When the characteristic 6330 of the movement data candidate characteristic management table 6300 is the same as the server characteristic 6650 of the acquired storage destination search server, the flow returns to Step S402. When the characteristic 6330 of the movement data candidate characteristic management table 6300 differs from the server characteristic 6650 of the acquired storage destination search server, the movement data candidate 6310 is assumed as the movement data 6410, and the flow proceeds to Step S404.

In Step S404, the unit determines the movement source search server 6420 and the movement destination search server 6430 of the movement data 6410.

First, the movement destination search server ID 6431 is determined. When the characteristic 6330 is “aggregate”, the file search server 3000 is assumed as the movement destination search server 6430. When the characteristic 6330 is “search”, the table search server 2000 is assumed as the movement destination search server 6430. With reference to the search server characteristic management table 6600, the unit extracts a search server group having the characteristic 6330. A search server is selected from the extracted search server group. The search server ID 6610 corresponding to the selected search server is assumed as the movement destination search server ID 6431.

Next, the movement destination directory name 6432 is determined. When the movement destination search server 6430 is the file search server 3000, “descriptions of/fss/table name with small letters” is registered as the movement destination directory name 6432. Specifically, when the table name 6311 is “TBL3”, the movement destination directory is “/fss/tbl3”.

When the movement destination search server 6430 is the table search server 2000, “N/A” is registered as the movement destination directory name 6432.

By the above process, the movement destination search server ID 6431 and the movement destination directory name 6432 are determined.

The storage destination search server ID 6130 is registered as the movement source search server ID 6421, and the storage destination directory name 6140 is registered as the movement source directory name 6422. A row is added newly to the data movement management table. The movement source search server ID 6421, the movement source directory name 6422, the movement destination search server ID 6431, and the movement destination directory name 6432 are registered. As the status 6440, “no movement yet” is registered, and the flow returns to Step S402.

In Step S405, a data movement instruction is sent to the data movement unit 1300.

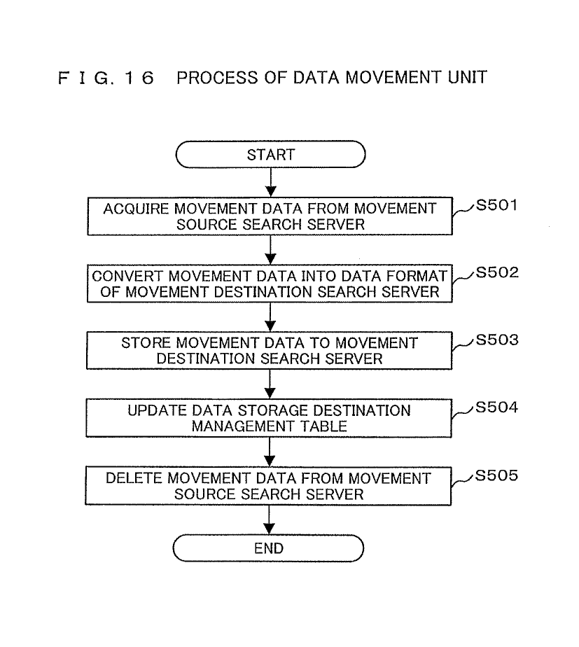

FIG. 16 illustrates the flow in which the data movement unit 1300 moves data. In this process, the data movement unit 1300 moves data from the table search server 2000 to the file search server 3000, or moves data from the file search server 3000 to the table search server 2000. For the sake of simplicity, in this example, it is supposed that the entire data stored in the file search server 3000 is a CSV file.

First, data is copied from the movement source search server 6420 to the movement destination search server 6430. After the copying is completed, the storage destination of the corresponding movement data in the data storage destination management table 6100 is changed from the movement source search server 6420 to the movement destination search server 6430. Finally, the movement data is deleted from the movement source search server 6420.

These are the descriptions of the simple flow of the data movement. Descriptions will hereinafter be made to the specific flow of the data movement.

First, the data movement unit 1300 receives a data movement instruction from the performance determination unit 1200. For each row of the data movement management table 6400, the data movement unit 1300 changes the status 6440 into “moving”, and executes the following process.

The data movement unit 1300 refers to the data movement management table 6400, to acquire the movement data 6410, the movement source search server 6420, and the movement destination search server 6430. Next, the data movement unit 1300 refers to the search server characteristic management table 6600, to acquire the representative IP address 6630 and the server type 6620 corresponding to the acquired movement source search server ID 6421.

The unit determines the server type 6620 of the acquired movement source search server 6420.

When the server type 6620 of the acquired movement source search server 6420 is “FSS”, the unit reads the movement data 6410 from the file search server 3000 (Step S501), converts it into a table format (Step S502), and stores it in the table search server 2000 (Step S503). More specific descriptions will be made below.

The data movement unit 1300 sends the acquired movement source directory name 6422 to the representative IP address 6630 of the acquired movement source search server 6420, that is, the representative node 3010. The representative node 3010 sends the received movement source directory name 6422 to each member node 3020. Each member node 3020 returns the CSV file stored in the movement source directory to the representative node 3010 (Step S501). The representative node 3010 integrates the received CSV file into the table data, and returns them to the data movement unit 1300 (Step S502).

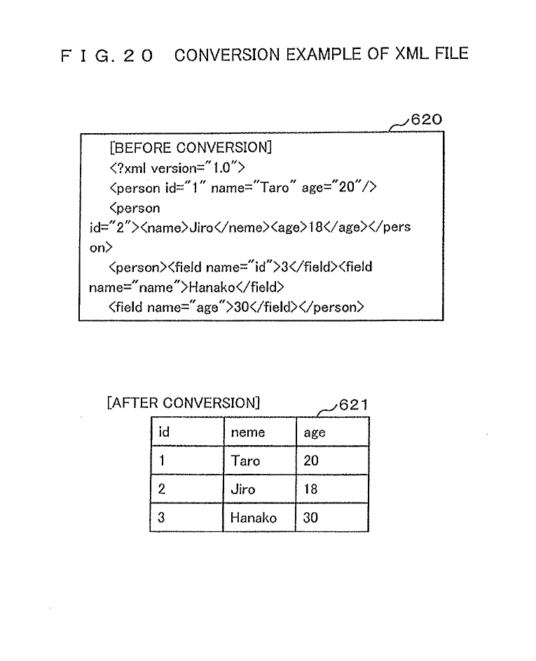

As described above, in this example, it is supposed that the entire data stored in the file search server 3000 is CSV files. For example, with the syntax of LOAD DATA INFILE of MySQL, the CSV file can be converted into table data. Similarly, with the syntax of LOAD XML INFILE of MySQL, the XML file can be converted into table data. For example, like FIG. 20, the XML file can be converted into table data.

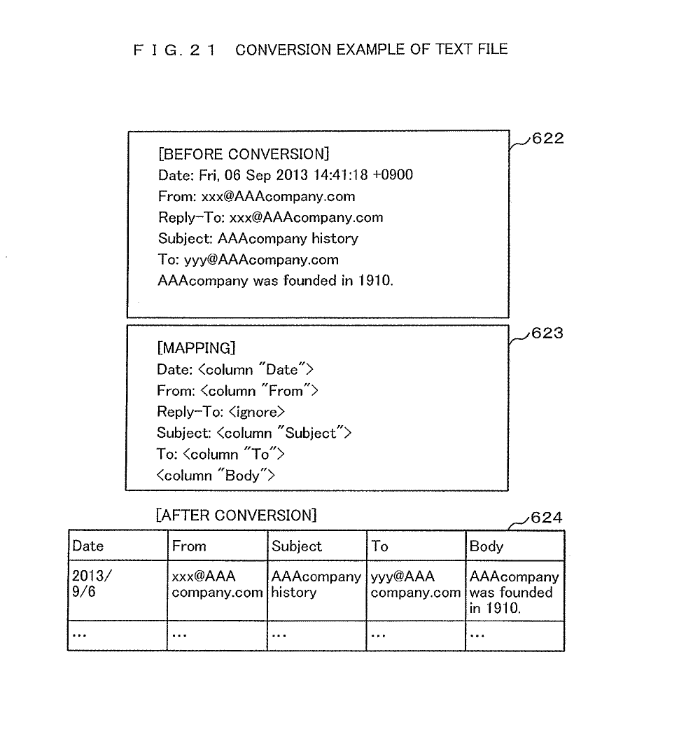

Some email clients can store emails in files. For example, Microsoft Outlook Express or Mozilla Thunderbird store emails in the file in the format of “eml”. In a text file having a set configuration, like the format of “Eml”, it is possible to convert it in table data, by defining mapping information like FIG. 21.

The data movement unit 1300 refers to the search server characteristic management table 6600, to acquire the representative IP address 6630 corresponding to the movement destination search server ID 6431. The data movement unit 1300 sends the table data and the table name 6411 to the acquired representative IP address 6630 of the movement destination search server 6430. The movement destination search server 6430 stores the table data in the table data memory area 2200 (Step S503).

When the server type 6620 of the movement source search server 6420 is “TSS”, movement data 6410 is read from the table search server 2000 (Step S501), the table data is divided, and converted into a file format (Step S502). Then, it is stored in the file search server 3000 (Step S503). More specific descriptions will be made below.

The data movement unit 1300 sends the table name 6411 and the movement data search expression 6412 to the table search unit 2100 of the movement source search server 6420. The table search unit 2100 reads the received table name 6411 and the data group specified by the movement data search expression 6412, from the table data memory area 2200, and returns them to the data movement unit 1300 (Step S501).

The data movement unit 1300 refers to the search server characteristic management table 6600, to acquire the representative IP address 6630 and the number of nodes 6640, corresponding to the movement destination search server ID 6431. The data movement unit 1300 divides the received data group into the number of nodes 6640, and converts them from the table data into the CSV files (Step S502). See FIG. 21 for an example of a conversion method into the CSV file. The data movement unit 1300 sends the corresponding CSV file together with the movement destination directory name 6432, to the file search unit 3110 of the representative node 3010 of the movement destination search server 6430.

The file search unit 3110 of the representative node 3010 sends the received CSV file to the file search unit 3120 of each member node 3020. The file search unit 3120 of each member node 3020 with the received CSV file stores the CSV file into the file data memory area 3200 (Step S503).

By these procedures, the data is completely copied from the movement source search server 6420 to the movement destination search server 6430. Next, the unit updates the data storage destination management table 6100 (Step S504), and deletes the corresponding data from the movement source search server 6420 (Step S505). Specific descriptions will be made below.

The data movement unit 1300 adds a row corresponding to the moved data to the data storage destination management table 6100, and registers the table name 6110 of the movement data, the movement data search expression 6120, the movement destination search server ID 6431 as the storage destination search server ID 6130, and the movement destination directory name 6432 as the storage destination directory name 6140.

The data movement unit 1300 specifies data having the movement data search expression 6120 including the movement data search expression 6120, from the data storage destination management table 6100.

Next, the unit determines the remaining aggregation obtained by subtracting the data group specified by the movement data search expression 6120 on the movement source, from the data group specified by the movement data search expression 6120. The unit determines the movement data search expression 6120 specifying the aggregation, and registers it as the movement data search expression 6120 specified in the data storage destination management table 6100 (by this registration, the first row of FIG. 5 is the first row of FIG. 11) (Step S504).

The data movement unit 1300 changes the status 6440 of the movement data of the data movement management table 6400 into “movement completed”.

The unit determines whether the server type 6620 of the movement source search server 6420 is “FSS” or “TSS”. When the server type 6620 of the movement source search server 6420 is “FSS”, each member node 3020 deletes the CSV file from the file data memory area 3200. When the server type 6620 of the movement source search server 6420 is “TSS”, the table search unit 2100 deletes the data group from the table data area (Step S505).

The above steps are executed for the movement data of the data movement management table 6400.

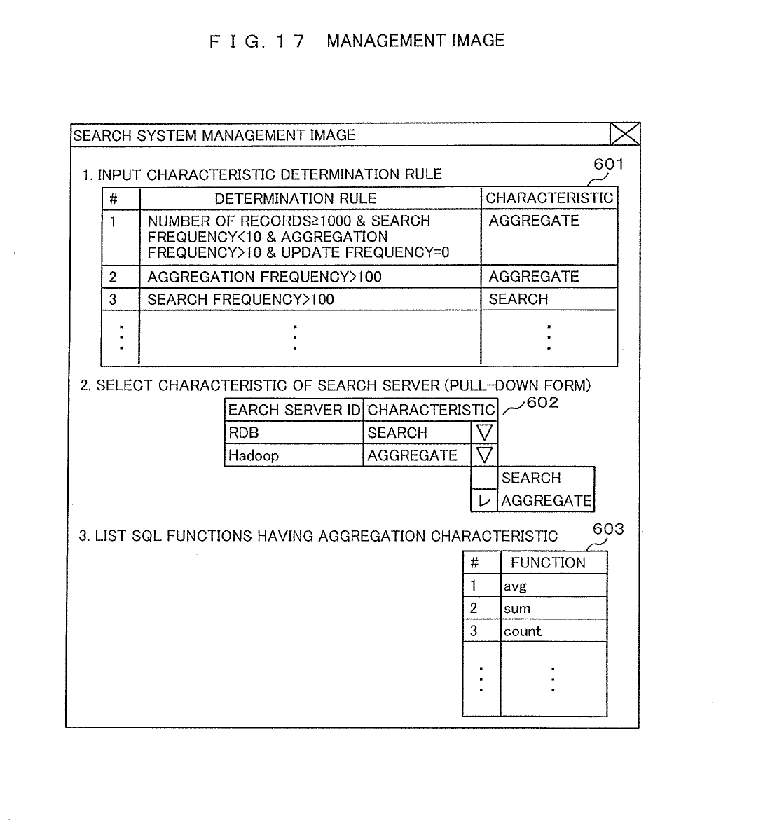

FIG. 17 is a diagram illustrating an example of a configuration of a management image of the search system 1000 which is generated by the management image generation unit 1400. In the example of this image, it is possible to input an input characteristic determination rule 601, characteristic information 602 of the search server which specifies whether the characteristic of the search server is “search” or “aggregate”, and an SQL function 603 having the characteristic “aggregate”. Through this management image, the search system management unit 4100 manages the search server characteristic management table 6600, the characteristic determination rule management table 6500, and the aggregate function management table 6700.

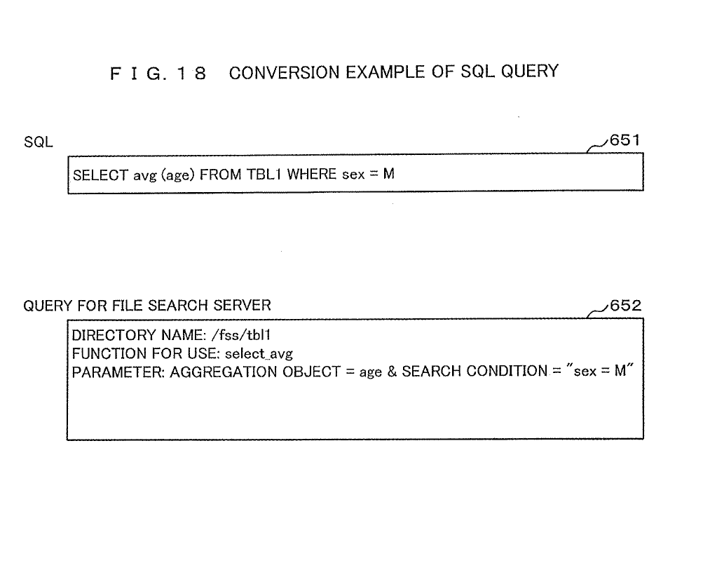

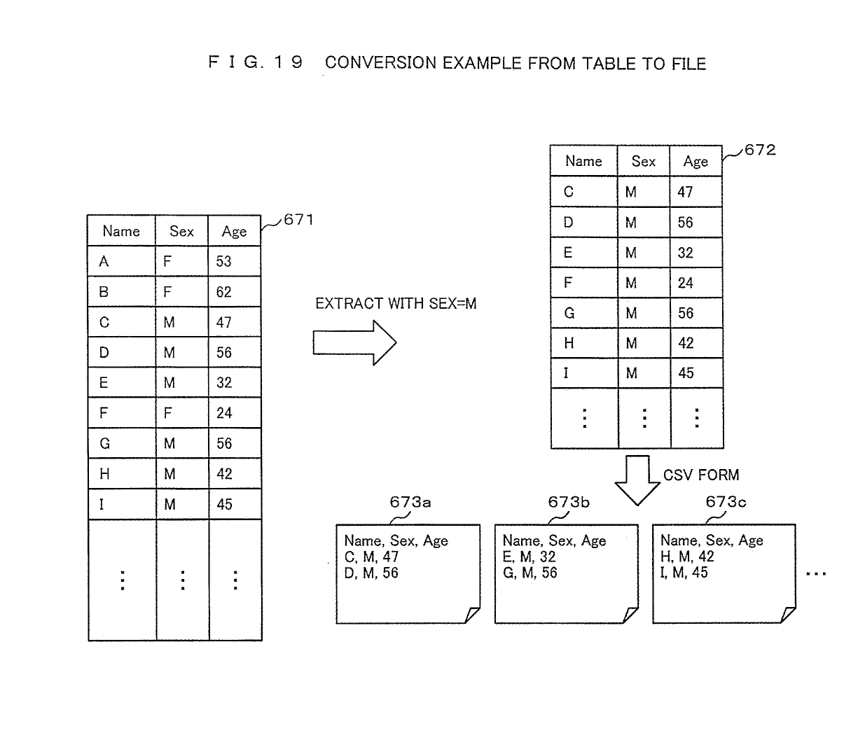

FIG. 18 is an explanatory diagram of an example in which an SQL query 651 has been converted into a format 652 processable by the file search server 3000.

FIG. 19 is an explanatory diagram of an example of table data 672 which has been created by extracting data in the unit of rows with a condition “sex=M” from table data 671, and has been formed in CVS to be converted in a file 673.

Accordingly, the descriptions have been made to the example 1 of the present invention. However, needless to say, the present invention is not limited to the example 1, and various configurations are possible without departing from the scope and spirit thereof.

For example, as illustrated in FIG. 4, in this example, it has been supposed that the data is stored in any of the table search server 2000 suitable for searching and the file search server 3000 suitable for aggregation. However, in the present invention, a search server having the third characteristic may be used as a data storage destination candidate, in addition to the above two kinds of search servers. At this time, the process for the search query, the data characteristic determination, and the data movement are performable in accordance with the above-described methods.

### REFERENCE SIGNS LIST

1000 . . . Search System,
1100 . . . Integrated Search Unit,
1200 . . . Performance Determination Unit,
1300 . . . Data Movement Unit,
1400 . . . Management Image Generation Unit,
1500 . . . Timer,
2000 . . . Table Search Server,
2100 . . . Table Search Unit,
2200 . . . Table Data Memory Area,
3000 . . . File Search Server,
3010 . . . Representative Node,
3020 . . . Member Node,
3100, 3110, 3120 . . . File Search Unit,
3200, 3210, 3220 . . . File Data Memory Area,
4000 . . . Client Machine,
4100 . . . Search System Management Unit,
4200 . . . Data Analysis Unit,
5000 . . . Network,
6100 . . . Data Storage Destination Management Table,
6110 . . . Table Name,
6120 . . . Movement Data Search Expression,
6130 . . . Storage Destination Search Server ID,
6140 . . . Storage Destination Directory Name,
6200 . . . Search Query History Management Table,
6300 . . . Movement Data Candidate Characteristic Management Table,
6400 . . . Data Movement Management Table,
6500 . . . Characteristic Determination Rule Management Table,
6600 . . . Search Server Characteristic Management Table,
6700 . . . Aggregate Function Management Table.

1. A search system including a table search unit for searching for data in a table format and a file search unit for searching parallelly for data in a plurality of file formats, comprising:
a table data memory area which stores target table format data to be searched by the table search unit;
a file data memory area which stores target file format data to be searched by the file search unit;
a performance determination unit which specifies a part of the table format data, in unit of rows, which is recognized to be searched at a high speed when it is searched as file format data, when the table search unit searches for the table format data;
a data movement unit which stores the specified part of the table format data in the unit of rows in a file, and moves it to the file data memory area; and
an integrated search unit which distributes a received search query to the table search unit and the file search unit.

2. The search system according to claim 1, comprising
a data storage destination management table for storing target data to be searched and a memory area of the data in association with each other, and wherein
the integrated search unit sends a search query to any of the search units for searching for target data to be searched in the search query, based on the data storage destination management table.

3. The search system according to claim 2, wherein
when the search unit searching for the target data to be searched cannot be specified, the integrated search unit sends a search query to a plurality of possible search units for searching.

4. The search system according to claim 2, comprising
a search query history management table which stores an execution history of the search query, and wherein
data in the table data format is stored in the file data memory area, when a data amount of the target data to be searched in the search query is greater than a preset capacity, or when a search execution time for the search query is longer than a preset search execution time.

5. The search system according to claim 4, wherein
when a determination result using a search execution time is different from a determination result using another condition, a storage destination is determined based on the determination result using the search execution time.

6. The search system according to claim 2, comprising
a search query history management table which stores a search query history management table which stores an execution history of the search query, and wherein
data in the table data format is stored in the file data memory area, when a processing frequency of an aggregation process for the target data to be searched in the search query is greater than a preset frequency, in a past search query execution result managed by the search query history management table, based on the search query history management table.

7. A search method of a search system including a table search unit searching for data in a table format and a file search unit searching for data in a plurality of file formats, comprising:
storing target table format data to be searched by the table search unit, in a table data memory area; and
storing target file format data to be searched by the file search unit, in a file data memory area; and wherein
a performance determination unit specifies a part of the table format data, in unit of rows, which is recognized to be searched at a high speed when it is searched as file format data, when the table search unit has searched for the table format data,
a data movement unit stores the specified part of the table format data in the unit of rows to a file, and moves it to the file data memory area, and
an integrated search unit distributes a received search query to the table search unit and the file search unit.

8. The search method according to claim 7, comprising
a data storage destination management table storing target data to be searched and a memory area for the data, in association with each other, and wherein
the integrated search unit sends a search query to any of the search units for searching for target data to be searched in the search query, based on the data storage destination management table.

9. The search method according to claim 8, wherein
when the search unit for searching for the target data to be searched cannot be specified, the integrated search unit sends a search query to a plurality of possible search units for searching.

10. The search method according to claim 8, comprising
a search query history management table storing an execution history of the search query, and wherein
data in the table data format is stored in the file data memory area, when a data amount of the target data to be searched in the search query is greater than a preset capacity, or when a search execution time for the search query is longer than a preset search execution time.

11. The search method according to claim 10, wherein
when a determination result using a search execution time is different from a determination result using another condition, a storage destination is determined based on the determination result using the search execution time.

12. The search method according to claim 8,
a search query history management table which stores a search query history management table which stores an execution history of the search query, and wherein
data in the table data format is stored in the file data memory area, when a processing frequency of an aggregation process for the target data to be searched in the search query is greater than a preset frequency, in a past search query execution result managed by the search query history management table, based on the search query history management table.
